(19) United States
(12) Patent Application Publication
(10) Pub. No.: US 2010/0115294 A1
(43) Pub. Date: May 6, 2010

(54) Delayed shutdown system for auxiliary power supply device of personal computer

(76) Inventor: Kuan-Wei Hsieh Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/289,629

(22) Filed: Oct. 31, 2008

(51) Int. Cl. G06F 1/00

(52) U.S. Cl. 713/300

(57) ABSTRACT

Disclosed is a delayed shutdown system applicable to a computer system including two power supply devices and a slave power supply interface card. A secondary power supply device of the delayed shutdown system serves as an auxiliary power supply to the computer system. The slave power supply interface card includes a delayed shutdown circuit, which delays the shutdown of the auxiliary power supply when the computer system is shut down, so that after the computer system is shut down, the secondary power supply device is maintained in operation for a given period of time. Thus, even the peripheral devices connected to the slave power supply interface card are set in a signal silent condition after the computer is shut down, they can maintain in operation with the electrical power supplied from the auxiliary power supply during the given period of time and thus they are provided with sufficient time complete a smooth shutdown operation by returning to a home position/an original condition and sufficiently dissipating heat therefrom.

### FIELD OF THE INVENTION

The present invention relates to a delayed shutdown system applicable to an auxiliary power supply device of a computer, and in particular to a circuit design that provides a delayed shutdown circuit that is arranged on a slave power supply interface card and connected to the auxiliary power supply device so that when the computer is shut down (namely a main board or a primary power supply device being shut down), a shutdown signal is transmitted to the slave power supply interface card to cause a delayed shutdown of the auxiliary power supply device, allowing the auxiliary power supply device to maintain supplying of electrical power to peripheral devices whereby the peripheral devices, although staying in a signal silent condition caused by the shutdown of the computer, remains capable to smoothly shut down, this being applicable to a desktop computer system, a thin client computer system, a miniature computer system, and the likes.

### BACKGROUND OF THE INVENTION

With the quick development of technology, computer systems evolve fast from the early DOS system, WINDOWS system, to the recently available VISTA system. The operation speed gets increasingly fast and consequently, high-standard computer hardware is required, including at least central processing unit (CPU), memory, and graphic acceleration card. The computer peripheral devices are also getting versatile, such as high-speed optic disk drive, external backup hard disk drive, card reader, USB slot, heat dissipation fan and the likes.

Conventionally, the computer hardware and the peripheral devices are both powered by the same power supply device. Apparently, the load of supplying power from the power supply device gets heavy with the development of the computer and peripheral devices and high power (wattage) power supply devices are needed to sufficiently supply power to the computer hardware and the associated peripheral devices. In addition, due to the different specifications that the hardware may take, the power supply device has to be upgraded with the development of the computer hardware. For example, the old type power supply device of former P2 or P3 specification is not suitable for a computer main board of P4 specification. Thus, the power supply devices are also of various models, such as AT and ATX.

For example, FIG. 7 of the attached drawings illustrate a layout of multiple electrical connection ports on a circuit board of a conventional power supply device, which is of an ATX model having 24 pins or terminals. On the other hand, an AT model has only 20 pins. Both the ATX model and the AT model provide multiple electrical input/output pins, among which a PS-ON/PS-OFF pin receives an input of a PS-ON/PS-OFF signal. An input of the PS-ON signal starts up the power supply device, while an input of the PS-OFF signal shuts down the power supply device. In the operation of the power supply, some of the pins supply output voltages of for example 24V, 12V, 5V and 3.3V. On the other hand, when the power supply device is shut down, these pins provide no voltage and electrical power. Thus, controlling the input signal to the PS-ON/PS-OFF pin may selectively start up or shut down all the peripheral devices that are supplied with power from the power supply device. The present invention provides a delayed shutdown system for an auxiliary power supply device of a computer, of which the auxiliary power supply device has an electrical connection port of which the 16th pin functions to provide the PS-ON/PS-OFF signal for controlling the ON/OFF states of the auxiliary power supply device.

Currently, one of the most commonly known ways of upgrading computer hardware or peripheral devices is to remove and replace a small power (wattage) power supply device or one that does not meet the new P4 standards with a new power supply. The removed old power supply device is then disposed of and treated as a waste.

Due to the current trend of environmental conservation, simply disposing of a small power (wattage) power supply device or one that does not meet the new standards without a though for re-using may cause pollution to the environment and a creation of garbage. This is ironic for the modern society that seeks for sustainable use of the natural environment.

In addition, when a computer is shut down, it may simply follow prescribed process to shut down in a normal way, or it may shut down abnormally without following the prescribed shutdown process. For a normal shutdown, data can be properly stored or a magnetic head can be properly set. However, for abnormal shutdown, which often occurs abruptly, data may get lost and magnetic disk or magnetic head is damaged. Abrupt power off often leads to inadvertent damage to disk drives.

Further, conventionally, fans and water pumps will immediately shut down when a computer is shut down. However, electronic parts of the computer that are already put in high temperature by the operation and process executed for shutting down the computer. Additionally, immediately after the computer is shut down, saturated capacitors of the computer continue discharge of electricity. Thus, the temperature of the computer rises to an apex point without any head dissipation realized by the heat dissipation facility that is shut down with the computer. This is referred to as temperature rising effect. This often causes burn-down of the electronic parts or chips. Apparently, it is insufficient to cool down with only by natural convection of air flow (with no operation of the head dissipation facility) after the computer is shut down.

Thus, the present inventor attempts to provide a delayed shutdown system that uses an old-fashion and out-of-date as a secondary, auxiliary power supply device for a computer system to share the load of power supply with a primary power supply device of the computer system and to effect s delayed shutdown after the computer system is shut down, for the purposes of overcoming the above discussed problems and drawbacks.

### SUMMARY OF THE INVENTION

An objective of the present invention is to provide a delayed shutdown system applicable to an auxiliary power supply device of a personal computer, wherein a slave power supply interface card comprises a delayed shutdown circuit that allows the auxiliary power supply device to be shut down in a delayed fashion whereby after the computer is shut down, the auxiliary power supply device maintains in operation for a preset time period for maintaining the operation of peripheral devices coupled thereto until the peripheral devices are safely and smoothly shut down, thereby enhancing safety of the computer system.

Another objective of the present invention is to provide a delayed shutdown system for an auxiliary power supply device of a personal computer, which allows for simultaneous operation of two power supply devices associated with a single computer by means of a signal connection port provided on a slave power supply interface card in communication with the computer, wherein the signal connection port functions to receive a voltage-on or voltage-off signal (Vout≠0/Vout=0), which signal is converted and applied to the auxiliary power supply device through an electrical connection port provided on the slave power supply interface card for controlling the switching of the auxiliary power supply device between ON and OFF states so that the auxiliary power supply can be simultaneously turned on/off with the computer and serves as a slave power supply to the computer. As such, the whole computer system can be started up or shut down through actuation of a signal button and the convenience of operation of the computer system is enhanced.

To realize the above objective, the present invention provides a delayed shutdown system that is applicable to a computer system comprising two power supply devices including a primary power supply device and a secondary, auxiliary power supply device and a slave power supply interface card, wherein the primary power supply device is arranged in a computer host of the computer system and electrically connected to a computer main board to supply electrical power thereto and the secondary power supply device is connected to peripheral devices via the slave power supply interface card to provide additional electrical power thereto. The slave power supply interface card is inserted into and engages an expansion slot of the computer main board or is connected thereto by conductors. The slave power supply interface card comprises an electrical connection port, at least one power output port, a signal connection port, and a delayed shutdown circuit. The electrical connection port is electrically connected to the secondary power supply device for supplying the additional electrical power from the secondary power supply device to the slave power supply interface card so that the additional electrical power is further supplied to the peripheral devices via the at least one power output port. The signal connection port is in signal connection with the computer host (the main board or the primary power supply device) to receive a host shutdown signal from the computer host (the main board or the primary power supply device). The host shutdown signal is transmitted to the delayed shutdown circuit whereby a preset delayed shutdown time period set in the delayed shutdown circuit. The secondary power supply device is maintained in operation until the preset delayed shutdown time period has elapsed, whereby during the preset delayed shutdown time period, the secondary power supply device maintains the additional supply of electrical power that provides the peripheral devices with sufficient time to return to a home position/an original condition for shutdown and/or to sufficiently dissipate heat therefrom.

### BRIEF DESCRIPTION OF THE DRAWINGS

The present invention will be apparent to those skilled in the art by reading the following description of preferred embodiments thereof with reference to the drawings, in which:

FIG. 1 is a perspective view illustrating a first embodiment of the present invention;

FIG. 2 is an exploded view of the first embodiment of the present invention;

FIG. 3 is a schematic plan view of a slave power supply interface card in accordance with the present invention;

FIG. 4 is a perspective view illustrating a second embodiment of the present invention;

FIG. 5 is a schematic view illustrating a portion of the second embodiment of the present invention;

FIG. 6 is a block diagram of the present invention; and

FIG. 7 illustrates a layout of multiple electrical connection ports of a conventional power supply device.

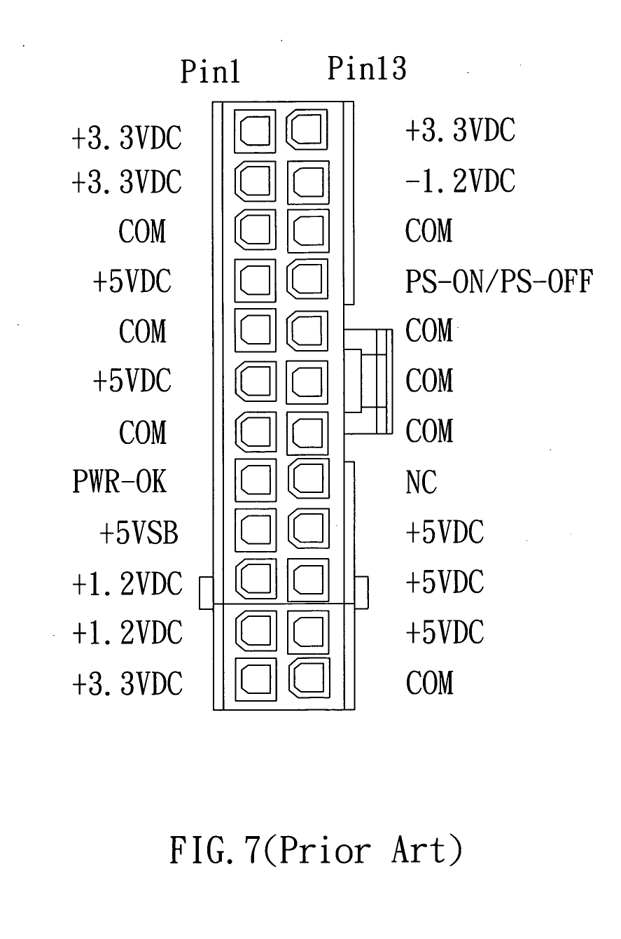

### DETAILED DESCRIPTION OF THE PREFERRED EMBODIMENTS

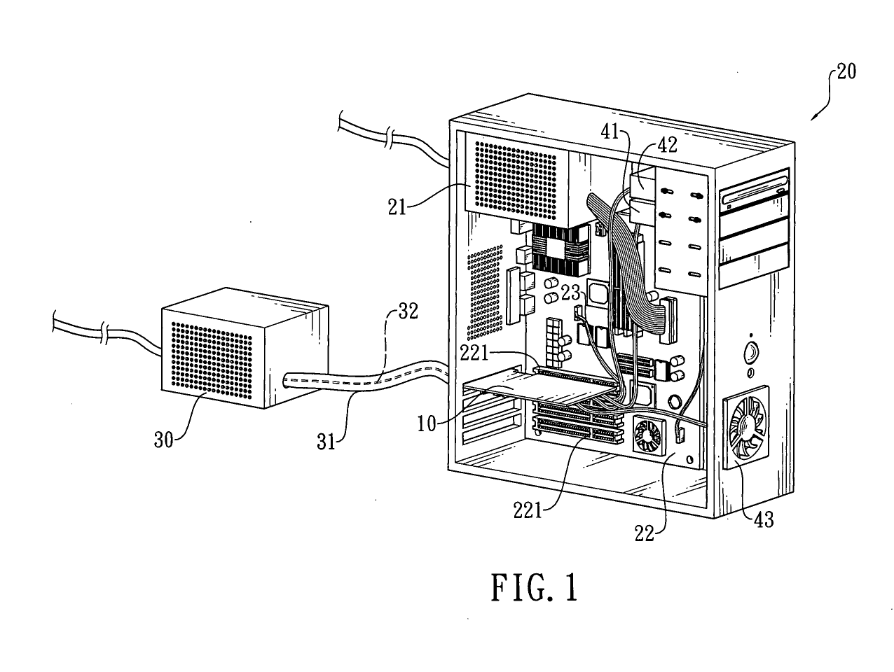

With reference to the drawings and in particular to FIGS. 1-3, which show a delayed shutdown system constructed in accordance with a first embodiment of the present invention applicable to an auxiliary power supply of a personal computer, the delayed shutdown system is composed of two power supply devices, namely a primary power supply device 21 and a secondary power supply device 30, and a slave power supply interface card 10. The primary power supply device 21 is built in the personal computer 20 and is electrically connected to a computer main board 22 to supply electrical power thereto. The secondary power supply device 30 is electrically connected to the slave power supply interface card 10 to provide additional electrical power. The slave power supply interface card 10 is inserted in and engages an expansion slot 221 of the main board 22. The slave power supply interface card 10 forms an electrical connection port 11, at least one power output port 12, a signal connection port 13, and a delayed shutdown circuit 14. The electrical connection port 11 is electrically connected to the secondary power supply device 30 for supplying the electrical power from the secondary power supply device 30 to the slave power supply interface card 10 and such electrical power is further supplied to peripheral devices 40 via connection thereof with the at least one power output port 12. The signal connection port 13 is in signal connection with the main board 22 to receive a shutdown signal from the main board 22. The shutdown signal is applied to the delayed shutdown circuit 14 to initiate a preset delayed shutdown countdown time period. The secondary power supply device 30 is not shut down until the countdown is completed and the preset delayed time period has elapsed. During the delayed shutdown time period, the secondary power supply device 30 maintains the supply of electrical power that provides the peripheral devices 40 with sufficient time and power supply to return to the home position or original condition for shutdown and/or to sufficiently dissipate heat therefrom.

In use, when the computer 20 is booted up and the primary power supply device 21 is set in operation (Vout≠0), with the connection of the main board 22 with the signal connection port 13 of the slave power supply interface card 10, a voltage-on signal (Vout≠0) is fed through a signal line 23 to the slave power supply interface card 10. The slave power supply interface card 10 converts the voltage-on signal (Vout≠0) into a PS-ON signal that is then applied to the electrical connection port 11 of the slave power supply interface card 10 and is further transmitted to the secondary power supply device 30 via a signal line 32 to thereby turn on the operation of the secondary power supply device 30 in a substantially synchronous manner, whereby the additional electrical power supplied due to the operation of the secondary power supply device 30 is fed back to the slave power supply interface card 10 and further supplied to the peripheral devices 40 through the at least one power output port 12. The peripheral devices 40 can be for example one or more of a floppy disk drive, a hard disk drive 41, an optic disk drive 42, a computer enclosure mounted fan 43, a CPU (Central Processing Unit) fan, a display card fan, a heat dissipation fan, and a water pump. The additional electrical power supplied from the secondary power supply device 30 is used to start up the operation of the peripheral devices 40. Due to the fact that two power supply devices are simultaneously used, the total amount of electrical power supplied is increased, which allows for operating extra facility.

When the computer system is shut down by turning off the primary power supply device 21 (Vout=0), due to the connection of the main board 22 with the slave power supply interface card 10, a voltage-off signal (Vout=0) is fed through the signal line 23 to the slave power supply interface card 10 and is forwarded through the signal connection port 13 to the delayed shutdown circuit 14 to initiate the countdown of the preset delayed shutdown time period that is set by the delayed shutdown circuit 14. In the respect, the delayed shutdown circuit 14 comprises a timer circuit 141 for time countdown. The timer circuit 141 can be set by factory or a user, or can be automatically set in accordance with environmental factors or through a preset logic algorithm. The environmental factor based setting of the timer circuit 141 can be operated on the basis of inside-enclosure detected temperature level, a preset value, or an operation condition flag of the computer. After the time delay has elapsed, the delayed shutdown circuit converts the voltage-off signal into a PS-OFF signal that is transmitted to the secondary power supply device 30. In this way, the shutdown of the power supply from the secondary power supply device 30 is delayed a preset time period, and this provides the peripheral devices 40 that are electrically connected to the power output port 12 of the slave power supply interface card 10 with sufficient time to return to the home position or original condition and/or sufficiently dissipate heat therefrom. The peripheral devices 40 can be for example one or more of a floppy disk drive, a hard disk drive 41, an optic disk drive 42, a computer enclosure mounted fan 43, a CPU fan, a display card fan, a heat dissipation fan, and a water pump. Thus, the shutdown of the peripheral devices is delayed, which allows the shutdown of the system more complete and smooth whereby enhanced stability and safety of the system can be obtained.

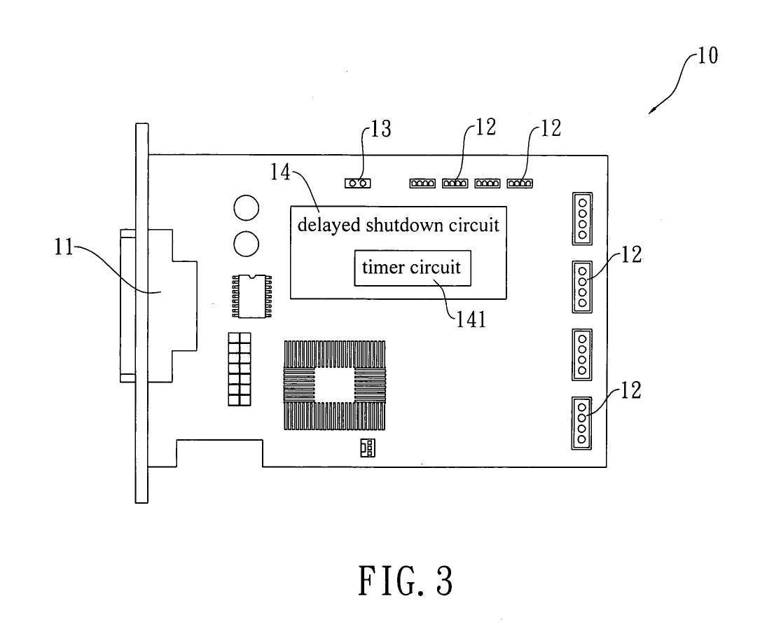

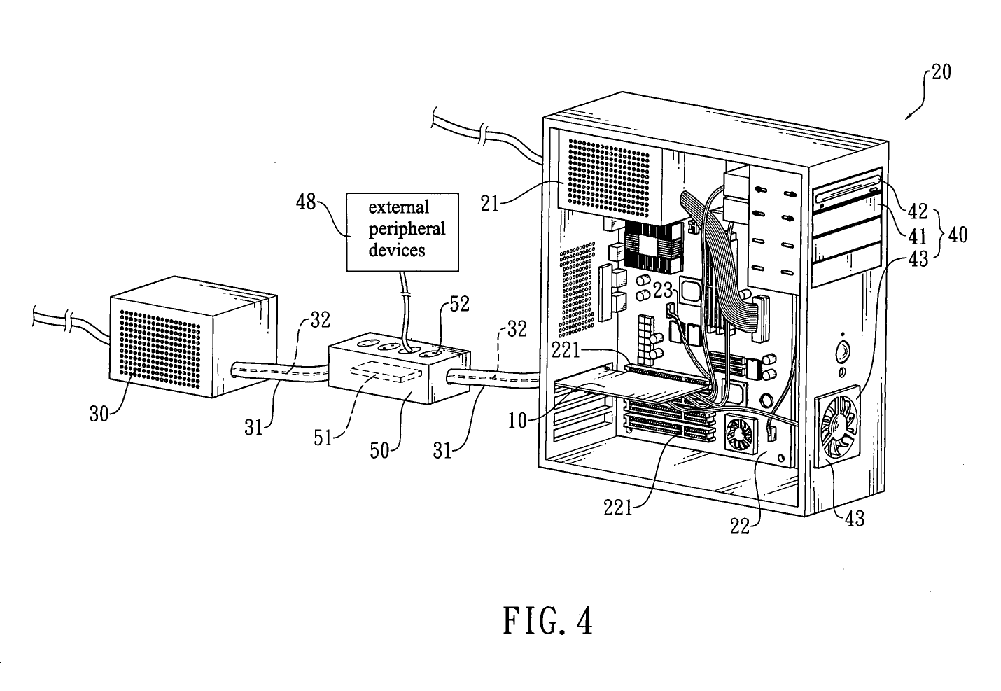

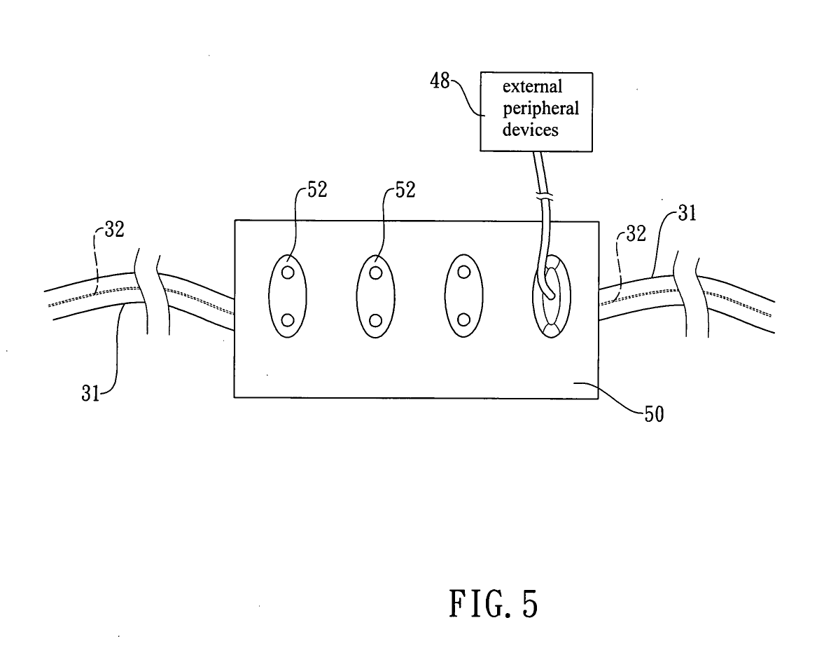

Referring to FIGS. 3-5, which show a second embodiment of the present invention, the slave power supply interface card 10 comprises an electrical connection port 11. Power lines 31 and signal lines 32 electrically connect among the slave power supply interface card 10, an adaptor box 50, and a secondary power supply device 30. Electrical power is supplied from the secondary power supply device 30 through the adaptor box 50 to the slave power supply interface card 10 for further supply to the peripheral devices 40 through at least one power output port 12. In other words, the adaptor box 50 is arranged between the secondary power supply device 30 and the slave power supply interface card 10 and the electrical connection port 11 is electrically connected to the adaptor box 50 through the power line 31. The adaptor box 50 comprises and contains therein a power conversion circuit 51. The electrical power from the secondary power supply device 30 is subjected to conversion by the power conversion circuit 51 into a desired voltage level (including for example 24V, 12V, 5V, and 3.3V) that is supplied through a power line 31 to the slave power supply interface card 10 for output through the at least one power output port 12. The adaptor box 50 can be provided with various external power connection ports 52 of various voltage levels for selective connection with external peripheral devices 48, such as a liquid crystal display, an external hard disk drive, an ADSL modem, a switching type hub, a rechargeable wireless mouse, and a scanner. The external peripheral devices 48 can be plugged into the external power connection ports 52 of the adaptor box 50 to receive the desired voltage level and electrical power. Although not illustrated in the drawings, optionally, the secondary power supply device 30 can be mounted inside the computer 20, whereby the computer 20 possesses two power supply devices of which a primary power supply device 21 is electrically connected to a main board 22 for supplying electrical power to the main board 22. The primary power supply device 21 is also set in electrical connection with the slave power supply interface card 10 via a signal line 23 to feed a voltage-on/voltage-off signal to the slave power supply interface card 10. The slave power supply interface card 10 converts the voltage-on/voltage-off signal (Vout≠0/Vout=0) into a PS-ON/PS-OFF signal that starts up and/or shuts down the secondary power supply device 30, whereby with the electrical connection of the electrical connection port 11 of the slave power supply interface card 10 with the secondary power supply device 30 through the power line 31 and the signal line 32, the signal is applied to the secondary power supply device 30 to start up or shut down the secondary power supply device 30 for supply of the additional electrical power. The secondary power supply device 30 can be directly connected to peripheral devices 40 of the computer 20 to supply the electrical power desired thereby. The peripheral devices 40 of the computer 20 can be for example one or more of a floppy disk drive, a hard disk drive 41, an optic disk drive 42, a computer enclosure mounted fan 43, a CPU fan, a display card fan, a heat dissipation fan, and a water pump. For environmental conservation, the secondary power supply device 30 can be a used, old-fashion power supply device or a low wattage power supply. In this way, the quantity of the disposed power supply devices can be reduced and the frequency of replacing or upgrading power supply devices is decreased. Although the primary power supply device 21 and the secondary power supply device 30 are both devices that supply electrical power, yet the electrical power supplied from them are not put in serial or parallel connection and is independently supplied to individual power consuming devices.

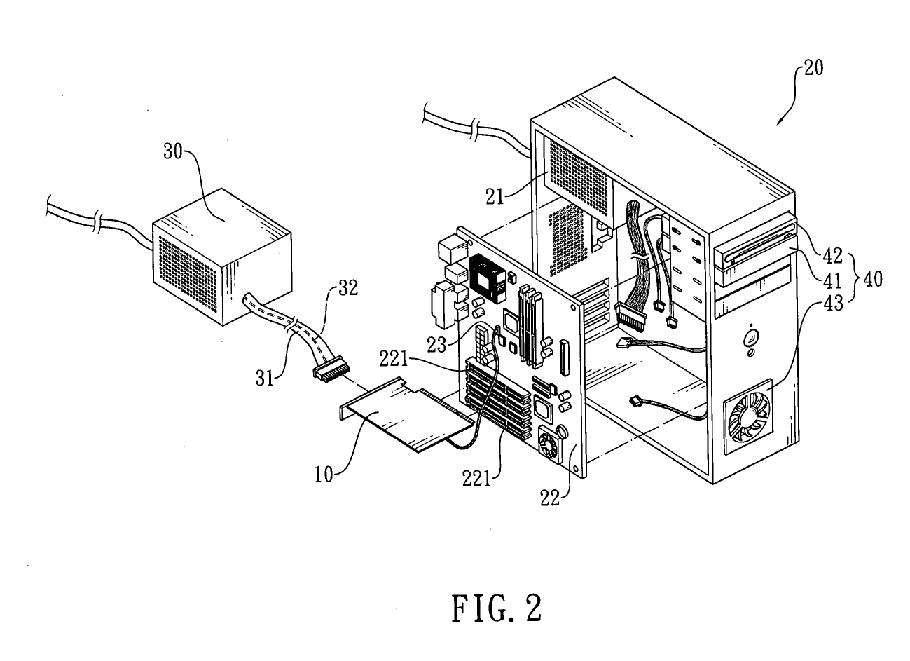

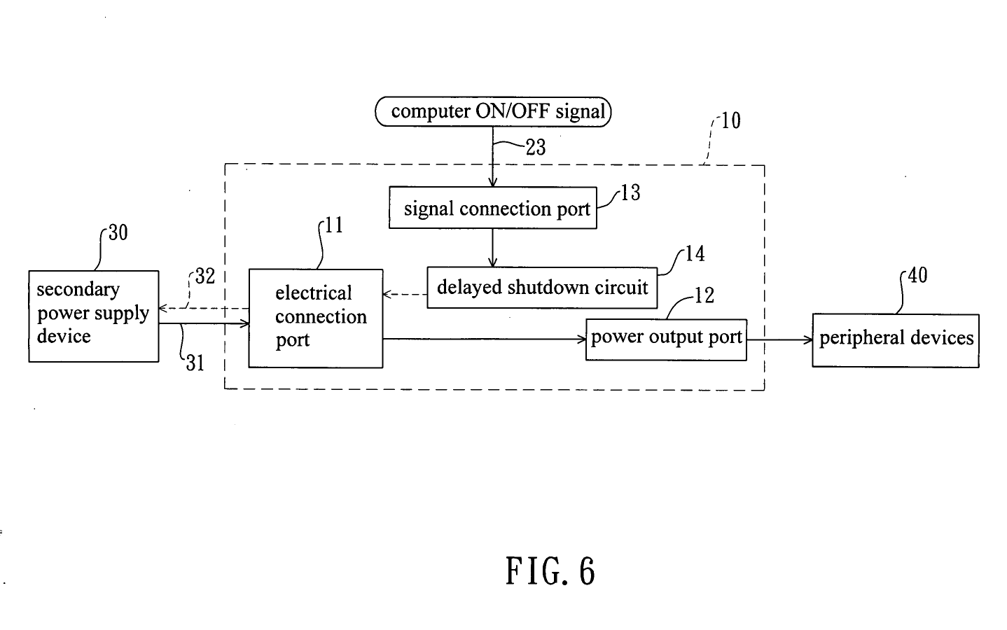

Referring to FIGS. 2 and 6, a block diagram of the present invention is illustrated (see FIG. 6), wherein a slave power supply interface card 10 is provided that comprises a signal connection port 13, an electrical connection port 11, a delayed shutdown circuit 14, and at least one power output port 12. The signal connection port 13 is set on the power output port 12 to receive, via a signal line 23, a voltage-on or voltage off signal (Vout≠0/Vout=0) from the computer 20 and the voltage-on/voltage-off signal (Vout≠0/Vout=0) is transmitted to the delayed shutdown circuit 14. The delayed shutdown circuit 14 sends the signal to the secondary power supply device 30 via the electrical connection port 11. The electrical connection port 11 is set at an edge of the slave power supply interface card 10 to provide multiple electrical transmissions. The power output port 12 is set on the slave power supply interface card 10 to supply electrical power to peripheral devices 40. As such, the computer system can obtain additional supply of electrical power for sharing the load of supplying power from the primary power supply device 21 and also realize system expansion so that after the main board 22 is shut down, the peripheral devices 40 can maintain operation for a preset of time period due to the additional supply of electrical power from the secondary power supply device 30. In this way, the peripheral devices 40 are provided with sufficient time to completely and smoothly shut down, making the computer system more stable and safe.

The present invention provides at least the following advantages:

(1) The present invention provides a computer system with a secondary power supply device that maintains supplying of power for a preset period of time after the computer system is shut down. In other words, the secondary power supply device itself is shut down in a delayed fashion and during such a delayed period of time, peripheral devices received electrical power from the secondary power supply device stay in a signal silence condition, but still receive sufficient power for a sufficient period of time, whereby the peripheral devices are allowed to smoothly shut down by for example completing storage of data and retracting a magnetic head. In this way, complete and smooth shut down of the peripheral devices is realized and the system is made more stable and safe.

(2) In the process of shutdown, the computer performs the operations thereof almost to the maximum extent due to the execution of the shutdown process. Thus, upon completely shutting down, the computer is of a very high temperature. Such a condition, plus the subsequent discharge of capacitors that reach a saturation condition during the shutdown process, which further make heat buildup in the electronic parts of the computer, drives the computer to an even higher temperature. In a conventional computer system that does not adopts the techniques of the present invention, after the shutdown of the computer system, the heat dissipation devices are also stopped for further operation, and consequently, such a high temperature condition may cause damage to the computer system. However, for the present invention, the heat dissipation devices of the computer are maintained in operation for a preset period of time after the computer system is shut down, whereby the high temperature and the buildup of heat can be removed and overcome, and the electronic parts of the computer system can be protected from overheating and burning down.

(3) With the primary power supply device and the secondary power supply device being set in a master-slave relationship, upon the booting of a computer system that adopts the techniques of the present invention, the secondary power supply device can be simultaneously started (to supply electrical power to peripheral devices associated therewith) and upon shutting down the computer system, the secondary power supply device carries out a delayed shutdown process (in cutting off power supplied to the peripheral devices associated therewith). In this way, the peripheral devices can be started up or shut down simultaneously with the computer. This provides convenience of the use of the computer system.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A delayed shutdown system for an auxiliary power supply device of a personal computer, comprising two power supply devices and a slave power supply interface card, wherein
the two power supply devices, which are respectively a primary power supply device and a secondary power supply device, the primary power supply device being arranged in the personal computer and electrically connected to a computer main board to supply electrical power thereto, the secondary power supply device being electrically connected to the slave power supply interface card to provide additional electrical power; and
the slave power supply interface card is set in electrical connection with the secondary power supply device, an ON/OFF signal of the computer, and peripheral devices, the slave power supply interface card comprising an electrical connection port, at least one power output port, a signal connection port, and a delayed shutdown circuit, the electrical connection port being electrically connected to the secondary power supply device for supplying the additional electrical power from the secondary power supply device to the slave power supply interface card so that the additional electrical power is further supplied to the peripheral devices that are connected to the at least one power output port, the signal connection port being in signal connection with the computer to receive the ON/OFF signal from the computer, the ON/OFF signal being applied to the delayed shutdown circuit whereby a preset delayed shutdown time period is initiated when the ON/OFF signal indicates shutdown of the computer, the secondary power supply device being maintained in operation until the preset delayed shutdown time period has elapsed, whereby during the preset delayed shutdown time period, the secondary power supply device maintains the additional supply of electrical power that provides the peripheral devices with sufficient time to return to a home position/an original condition for shutdown and/or to sufficiently dissipate heat therefrom.

2. The delayed shutdown system as claimed in claim 1 further comprising an adaptor box arranged between the electrical connection port of the slave power supply interface card and the secondary power supply device, wherein the adaptor box comprises a power conversion circuit that converts and supplies multiple electrical powers from the secondary power supply device to the electrical connection port of the slave power supply interface card.

3. The delayed shutdown system as claimed in claim 2, wherein the power conversion circuit of the adaptor box supplies the additional electrical power from the secondary power supply device to external power connection ports formed on the adaptor box for powering external peripheral devices connected thereto.

4. The delayed shutdown system as claimed in claim 1, wherein the peripheral devices comprises at least one device selected from a group including a floppy disk drive, a hard disk drive, an optic disk drive, a computer enclosure mounted fan, a central processing unit fan, a display card fan, a heat dissipation fan, and a water pump.

5. The delayed shutdown system as claimed in claim 3, wherein the external peripheral devices that are connected to the external power connection ports of the adaptor box comprises at least one device selected from a group including a liquid crystal display, an external hard disk drive, an ADSL modem, a switching type hub, a rechargeable wireless mouse, and a scanner.

6. The delayed shutdown system as claimed in claim 1, wherein the delayed shutdown circuit comprises a timer circuit for timing the preset delayed shutdown time period.
